(19) United States
(12) Patent Application Publication
(10) Pub. No.: US 2015/0326497 A1
(43) Pub. Date: Nov. 12, 2015

(54) GROUP BASED POLICY MANAGEMENT

(71) Applicant: Oracle International Corporation, Redwood Shores, CA (US)

(72) Inventors: Jerome Guionnet, Palo Alto, CA (US); Venkatesan Ramachandran, Bangalore (IN)

(73) Assignee: Oracle International Corporation, Redwood Shores, CA (US)

(21) Appl. No.: 14/272,700

(22) Filed: May 8, 2014

(51) Int. Cl. H04L 12/927; G06Q 20/14

(52) U.S. Cl. CPC H04L 47/808; G06Q 20/14

(57) ABSTRACT

The present disclosure provides for managing policies within a group. A group, which includes numerous group members, is configured to share resources from a single pool of resources. In addition, a group of policies applicable to the group are also identified. Whenever a request is received from one of the group members, a determination is made as to whether such a request violates the policies applicable to the group.

### FIELD OF THE INVENTION

This invention relates to policy management, and more particularly, to managing policies within a group.

### BACKGROUND OF THE INVENTION

Service providers offer services to one or more subscribers, where such services are defined and limited by one or more policies. These policies are typically defined and enforced on an individual subscriber basis. In some cases, services may be offered to a group of users or entities. It would be desirable to utilize and enforce existing policies on such groups.

### SUMMARY OF THE INVENTION

The present disclosure provides for managing policies within a group. A group, which includes numerous group members, is configured to share resources from a single pool of resources. In addition, a group of policies applicable to the group are also identified. Whenever a request is received from one of the group members, a determination is made as to whether such a request violates the policies applicable to the group.

### BRIEF DESCRIPTION OF THE DRAWINGS

The present invention may be better understood, and its numerous objects, features and advantages made apparent to those skilled in the art by referencing the accompanying drawings.

FIG. 1 is a simplified block diagram illustrating components of an example system in which the present disclosure may be implemented, according to one embodiment.

FIG. 2 is a flowchart illustrating an example process for generating policy information, according to one embodiment.

FIG. 3 is a flowchart illustrating an example process for processing policy information, according to one embodiment.

FIG. 4 is a flowchart illustrating an example process for identifying group information, according to one embodiment.

FIG. 5 is a flowchart illustrating an example process for identifying group policy information, according to one embodiment.

FIG. 6A is a flowchart illustrating an example process for checking group policies, according to one embodiment.

FIG. 6B is a flowchart illustrating an example process for checking group policies, according to one embodiment.

FIG. 7 is a flowchart illustrating an example process for enforcing group policies, according to one embodiment.

FIG. 8 is a flowchart illustrating an example process for modifying policy information, according to one embodiment.

FIG. 9 is a simplified block diagram of an example computer system for implementing aspects of the present disclosure, according to one embodiment.

FIG. 10 is a simplified block diagram of a network architecture suitable for implementing aspects of the present disclosure, according to one embodiment.

While the present disclosure is susceptible to various modifications in alternative forms, specific embodiments of the present disclosure are provided as examples in the drawing in detailed description. It should be understood that the drawings in detailed description are not intended to limit the present disclosure to the particular form disclosed. Instead, the intentions are to cover all modifications equivalent and alternatives falling within the spirit and scope of the present disclosure as defined by the appended claims.

### DETAILED DESCRIPTION

Services may be offered to a customer (e.g., a paid subscriber) by a customer service provider. Some examples of such services may include television services, phone services, internet services, and the like by a telecommunications provider, shipping services by a shipping provider, utility services by a utility service provider, and so on.

The use of such services is rated and billed to the customer, according to terms defined within a service agreement (e.g., an agreement between the customer and the customer service provider which defines applicable rates for the service). In addition, these services are typically rendered to the customer according to a set of policies. Policies represent rules to be applied when providing the service to the specific customer (e.g., according to the details of the customer's paid subscription). For example, a policy for a telecommunications customer may specify that the customer may stream up to 5 movies in high definition (HD) per month and then still enable the customer to stream movies thereafter, but in standard definition. Another example policy for a telecommunications customer may specify that the customer may access internet from any mobile device with the highest quality of service (e.g., high bandwidth) up to 5 GB per month and then throttle the bandwidth thereafter.

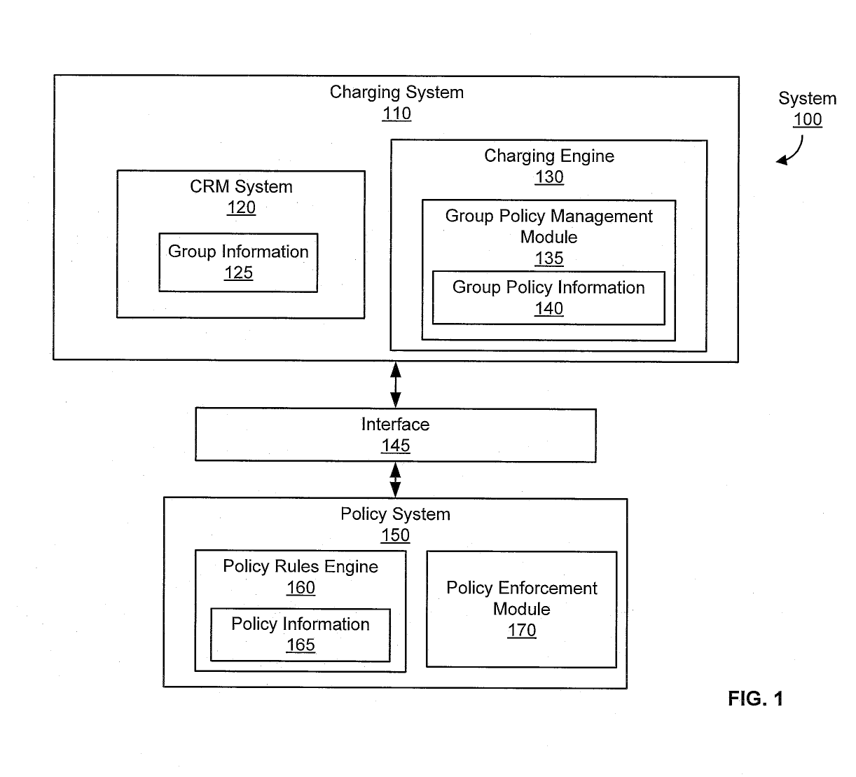

Policies are typically defined on an individual subscriber basis and pertain to one or more resources (e.g., a total amount of services) available to the individual subscriber. In many cases, however, services are offered to a group of subscribers, where such a group shares resources from a single pool of resources. For example, a telecommunications service provider may offer a family plan, where all members of the family share from a single pool of data usage amounts. The system of FIG. 1 allows policies to be defined and enforced for a group of subscribers that share a single pool of resources.

FIG. 1 illustrates an example system, in which the present disclosure can be implemented. System 100 includes a charging system 110 (which further includes a customer relations management (CRM) system 120 and a charging engine 130), an interface 145, and policy system 150 (which further includes policy rule engine 160 and policy enforcement 170). The elements of FIG. 1 allow for the identification of a group of subscribers, as well as the identification and enforcement of applicable policies within the group of subscribers.

CRM system 120 is a system that receives information (e.g., from a subscriber and/or the customer service provider) regarding a service agreement for a group of subscribers. A service agreement offered to a group of subscribers sharing a pool of resources is herein after referred to as a sharing agreement. CRM system 120 may include a user interface that presents service, pricing, and policy options to one or more subscribers of the group, enables the selection of one or more options from the user interface, and allows the subscriber to enter further details regarding the group of subscribers (e.g., characteristics of the group members, including names, ages, preferences, and so on). In other embodiments, CRM 120 may be used by the customer service provider, who can perform the same functionality on behalf of the group of subscribers.

CRM system 120 uses the sharing agreement information to generate and store group information 125. Group information 125 identifies the group. For example, group information 125 may identify a group owner (e.g., the group member responsible for controlling and paying bills related to the services) and all remaining group members. In addition, group information 125 may also identify the pool of resources, including any and all categories and subcategories of resources within the pool of resources. As an example, a pool of resources may include a category for phone services, which includes a subcategory for local calls and another subcategory for international calls. In another example, the pool of resources may include a quality of service for video sessions, a quality of service based on devices, a quality of service based on location, blackout periods, and so on.

Group information 125 is stored in CRM system 120 and shared with charging engine 130, as needed. For example, charging engine 130 may query CRM system 120 for group information 125 in order to identify and process service requests from a group member. In addition, CRM system 120 may also maintain billing and revenue information for any services rendered to the group. Such information may be generated using rating information received from charging engine 130.

Charging engine 130 is an engine that rates incoming service requests, based on the most up-to-date balance information maintained for each subscriber, including the group of subscribers (e.g., balances for all categories and subcategories within the pool of resources). Upon rating service requests, charging engine 130 applies applicable charges for the service to the balances within the pool of resources, thereby maintaining the most up-to-date balances for the pool of resources. In addition, charging engine 130 utilizes such balance information to check for and enforce policies on a group level.

Upon receipt of a service request originating from a group member, charging engine 130 determines whether the service request is allowable and/or how to process (e.g., rate and charge for) the service request. Such determinations are based on the remaining balances within the pool of resources. In addition, such determinations may also be based on one or more policies defined for the group of subscribers.

Group policies are defined and maintained by group policy management module 135. In particular, group policy management module 135 identifies and associates any and all policies that are related to a group of subscribers and stores such information as group policy information 140. Group policy management module 135 receives policy information (e.g., information regarding policies, policy triggers, and notifications) from policy system 150. The policy information maintained by policy system 150 is identified as policy information 165. Policy information 165 is generated and maintained on an individual subscriber basis (e.g., without regard to any groups of subscribers). Group policy management module 135 utilizes policy information 165 and group information 125 to identify any policies that are applicable to a group of subscribers. The identified policies (along with corresponding policy triggers and notifications) are associated with the group and stored as group policy information 140. Group policy information 140 is then used to process service requests from any member of the group.

Many policies within group policy information 140 may be based on remaining balances within a pool of resources. Thus, charging engine 130 can apply the most up-to-date balance information for the pool of resources (e.g., data which charging engine 130 already maintains) to process a service request and thereby determine whether the service request triggers some form of action, according to pre-defined group policy information.

In cases where a service request triggers some form of action, charging engine 130 (in conjunction with group policy management module 135) generates applicable notifications. These notifications may identify the policy and/or policy trigger encountered by charging engine 130. The applicable notifications are then transmitted to policy system 150 (e.g., via interface 145 or the like) for enforcement therein. In one example, the notification transmitted to policy system 150 may be a notification in the form of a message, a tag, or the like.

In cases where a service request is allowable, charging engine 130 identifies an applicable rate and charge for the service. Once such information is identified, information regarding such charges is transmitted to CRM system 120 in order to allow CRM system 120 to update billing and revenue information applicable to the group. In addition, charging engine 130 may also transmit additional notifications to policy system 150 regarding the service usage so that policy system 150 can adjust any policies, as needed.

Interface 145 can be any type of interface (e.g., media controllers, APIs, and the like, or any combination thereof) that allows communications (e.g., data exchanges) to occur between charging system 110 and policy system 150. Interface 145 may perform conversions necessary to allow such communications to occur. For example, charging system 110 may generate information using a form native to charging system 110 and/or policy system 150 may generate information using a form native to policy system 150. In such scenarios, interface 145 may perform a conversion from one form to another. As shown, interface 145 is a component independent from charging system 110 and policy system 150. Alternatively, interface 145 may be part of charging engine 110 or part of policy system 150. In even further embodiments, interface 145 may not be used and/or necessary.

Policy system 150 comprises a policy rules engine 160 and policy enforcement module 170. Policy rules engine 160 generates policy information 165, which identifies policies applicable to individual subscribers. Such policies may be defined by a policy administrator and/or the customer service provider. Policy rules engine 160 may receive information from charging engine 130 regarding usage of a service. This information can be used by policy rules engine 160 to update existing policy information 165. For example, certain levels of service usage may require new or modified policies. Once policy information 165 is updated, revised policy information is transmitted to policy enforcement module 170 for enforcement of the new or modified policies.

Policy enforcement module 170 enforces policies defined by policy rules engine 160. Such enforcement action is triggered by the receipt of a notification from charging engine 130 or by polling an initial status at session establishment. Such notifications may indicate the policy trigger encountered by charging engine 130 when attempting to process a service request (e.g., from a group member). Policy enforcement module 170 uses policy information 165 to identify the actions to be taken in response to such notifications. Some example actions that may be taken by policy enforcement module 170 include blocking a service request, sending notifications to one or more group members, and the like.

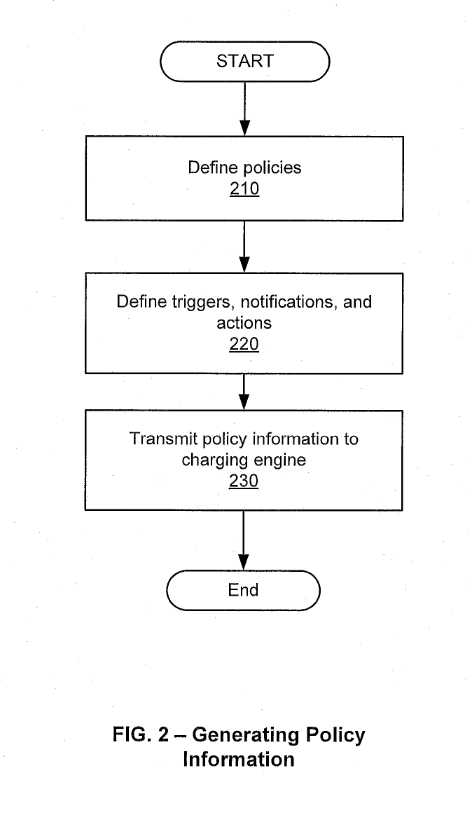

FIG. 2 illustrates an example process for generating policy information. The process of FIG. 2 is performed by a policy system, such as policy system 150 of FIG. 1.

The process of FIG. 2 begins at 210, where one or more policies are defined by a policy rules engine. Policies are typically defined on a subscription basis. This is because policies are directly correlated to a subscription (and pricing configurations therein), as selected by each individual subscriber. Once defined, policies are usable to determine how and when a service should be rendered to a subscriber.

Policies may be defined based on usage (e.g., the total amount of service usage that has been rendered to the subscriber within a given period of time). These types of policies are specifically tied to (or dependent upon) remaining balances for any and all resources allocated to the subscriber. For example, a policy may be defined to limit the amount of data usage that is allocated to a telecommunications subscriber, such as 10 Gb of data usage in a month. These types of policies may define that any usage that exceeds predetermined balances for the resources allocated to the subscriber may be denied or processed differently (e.g., charged at a premium cost).

Policies may also be defined based on the type of service being used. As an example, a subscriber for a cell phone may choose to download a video, access social media networks, and/or make a call, among other options. In this case, policies may be defined for each particular type of service being requested. Specifically, policies may be defined for the video download (e.g., rated using a first rate), the social media network (e.g., free of charge), and the call (e.g., rated using a second rate).

In addition, policies may also be defined based on time periods and/or a location for the service. Policies may define how to treat service requests that are received at particular time periods. Other policies may define how to treat service requests based on where a service request is coming from (e.g., what city, country, and the like). As an example, policies may define that local calls should be charged using a first rate per minute, while international calls should be charged using a second rate per minute.

Policies may also be defined based on different capabilities of a service provider. For example, a telecommunications service provider may have areas that offer 2G, 3G, 4G, or LTE network capabilities. A different set of policies may be defined for each capability. In the context of a shipping provider, capabilities may exist for shipping items to a subscriber within 1 day, 2 days, or 3-5 business days. Applicable policies may be defined for each capability.

Even further, policies may be defined based on applications or devices used when submitting a service request and/or receiving the service itself. For example, policies may be defined as to whether a service may be allowed depending on whether the service is to be rendered to a phone, personal computer, laptop, or tablet. In such a scenario, a request to watch a video may be allowed if the video will be viewed on a personal computer but disallowed if viewed on a tablet. Policies in this regard may be defined as part of 210.

Similar policies may also be defined to limit volume, bandwidth, or duration of a service. One example of such policies includes fair use policies, which help control a quality of service rendered to a subscriber. As will be appreciated, other types of policies can also be defined for a service. For example, policies may be defined to incorporate preferences that may be desirable or available to a subscriber. This might include, for example, policies allowing a parent to control usage by their children.

The process of FIG. 2 continues to 220, where policy triggers, notifications, and actions are defined. Policy triggers describe scenarios that may trigger some form of action by a policy system. These can include, for example, scenarios where service usage has reached a certain threshold, scenarios where a service request is prohibited based on customer preferences, and so on.

Notifications are also defined at 220 to describe the policy triggers, in a format that is usable by a policy system (e.g. for enforcement purposes). These notifications are to be made available to a charging engine, such as charging engine 130 of FIG. 1. Such notifications are usable by the charging engine to describe any and all applicable policy triggers encountered by a charging engine when processing a service request submitted by a subscriber.

Corresponding actions may also be defined at 220 to describe any actions to be taken in response to a policy trigger. Such actions can include blocking the service, applying a different rate to the service, applying a special bandwidth or capability to the service, allowing a new service to be tried out for free or at a lower cost, implementing parental controls (e.g., blocking adult sites for kids, prohibiting texts and data usage during school hours, and/or prohibiting data usage after certain hours of the day), sending notifications to a subscriber, and many others.

The process continues to 230, where the policy system transmits the applicable policy information to a charging engine, such as charging engine 130 of FIG. 1. The policy information that is transmitted to the charging engine may include the policies defined at 210, as well as corresponding triggers and notifications defined at 220. Such information enables a charging engine to apply (and thus take into consideration) such policies when processing service requests submitted by a subscriber. At this point, the process of FIG. 2 ends.

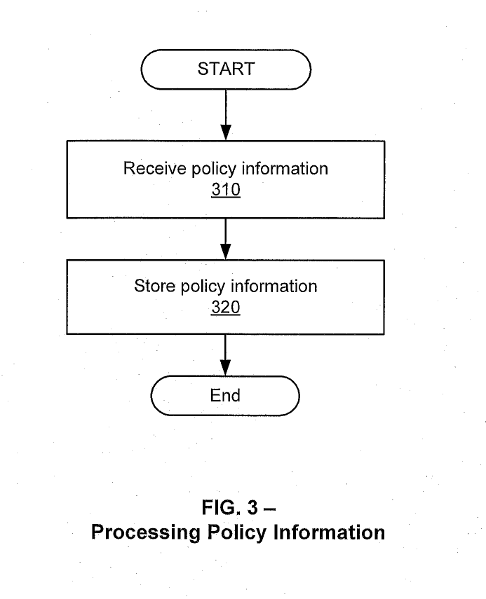

FIG. 3 illustrates a process by which policy information is processed. Such a process may be performed by a charging engine, such as charging engine 130 of FIG. 1, in combination with group policy management module, such as group management module 135 of FIG. 1.

The process of FIG. 3 begins at 310, where policy information is received by a charging engine. Policy information may be received from a policy system, such as policy system 150 of FIG. 1, via an interface, such as interface 145 of FIG. 1. Policy information may be generated at the policy system using a first form (e.g., a form that is native to the policy system). The interface may transform the policy information from the first form to a second form (e.g., a form that is native to the charging engine) prior to transmitting the policy information to the charging engine. Alternatively, the charging engine and the policy system may use the same form and thus no transformations may be needed.

The policy information received at 310 may include several types of information regarding policies to be used for individual subscribers. For example, policy information may include a set of one or more policies, a set of one or more policy triggers, and a set of one or more notifications. The process of FIG. 3 then continues to 320. At 320, the group policy management module stores the policy information received at 310 (e.g., as policy information for individual subscribers). At this point, the process of FIG. 3 ends.

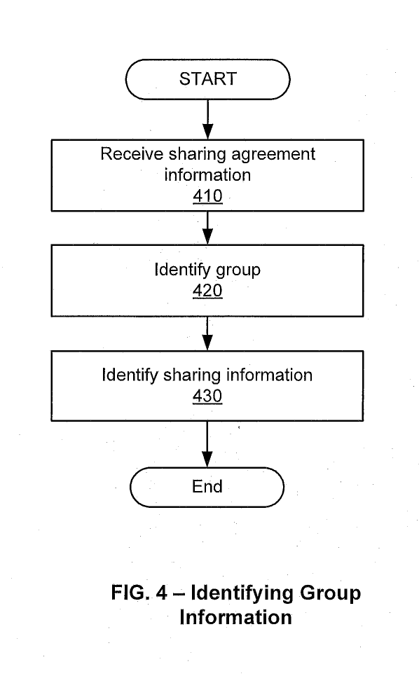

FIG. 4 illustrates an example process for identifying group information. The process of FIG. 4 is performed by charging engine, such as charging engine 130 of FIG. 1. In one embodiment, group information is received by a CRM system, such as CRM system 120 of FIG. 1, and thereafter shared with the charging engine 130, as needed.

The process of FIG. 4 begins at 410 where information regarding a sharing agreement is received. A sharing agreement is an agreement between a group owner and a group (e.g., a group of subscribers). A group owner, in such cases, is a logical entity that represents a physical person, a corporation, or other artifact. A sharing agreement typically includes information that helps identify the group and group resources to be shared within the group. A group may represent, for example, a group of people (e.g., a family), a group of machines (e.g., a group of machines managed by a corporation), or any other community or group of things.

At 420, the group is identified, using the information received at 410. For example, the sharing agreement information received at 410 can identify the total number of subscribers in the group, as well as the age and preferences for each subscriber in the group. A sharing agreement can also identify the group owner and the group members.

The process continues to 430, where sharing information is identified. Sharing information identifies a pool of resources to be shared within the group. A pool of resources can represent a number of different categories and/or subcategories. For example, a pool of resources for a group of subscribers may include a total amount of minutes available for phone calls, a total amount of text messages allowed, a total amount of data usage available, a total amount of credit, and so on, for a group of subscribers.

A pool of resources is typically associated with a starting amount or balance for each category and/or subcategory. Thus, such amounts and balances for each category and/or subcategory may be identified as part of 430. In addition, an applicable time period is also identified for the pool of resources. This time period identifies a starting and ending point for any usage within a pool of resources. An example time period for a pool of resources may be a day, a week, a month, or a year.

At this point, the process of FIG. 4 ends. Group information identified in FIG. 4 may change, as a result of changes made by the subscribers and/or the customer service provider. In such dynamic communities, a sharing agreement may be modified as a result thereof and the information identified at 420 and 430 may be changed accordingly to update the group information.

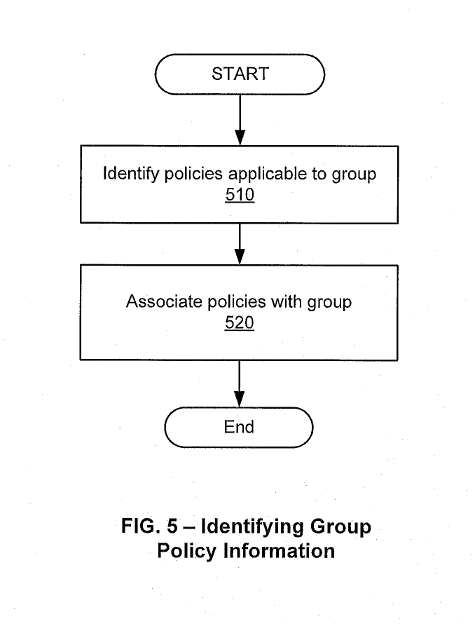

FIG. 5 illustrates a process for identifying group policy information. The process of FIG. 5 may be performed by a group policy management module, such as group policy management module 135 of FIG. 1.

The process of FIG. 5 begins at 510, where policies applicable to a pre-defined group are identified. Once a group has been identified, policy information maintained at the group policy management module is retrieved. Using the group information identified in FIG. 4, the group policy management module can identify one or more policies that are applicable to the group. In order to do so, the group policy management module may use various details regarding the group of subscribers and the pool of resources. For example, the group policy management module may use information regarding the age, location, and status of individual group members, as well as any relationships existing between group members to identify policies applicable to the group. The group policy management module may also use information regarding the pool of resources, associated balances for each category and/or subcategory, and any preferences and/or limitations identified by the group members to further identify policies applicable to the group.

Thereafter, the process continues to 520. At 520, the applicable policies identified in 510 are associated with the group. Such an association creates a relationship between the group of subscribers and the applicable policies (along with corresponding policy triggers and notifications). By doing so, the group policy management module can identify policy information on a group basis, and not just individual subscribers.

Once the associations of 520 have been made, the resulting policy information can be identified and stored as group policy information. The group policy information may then be used by the charging engine to process service requests received from a group member. The charging engine can identify policy triggers and generate corresponding notifications for use by the policy system. The notifications sent to the policy system may remain the same whether operating on an individual subscriber or a group basis, thereby enabling the functionality of a policy system to remain unchanged.

At this point, the process of FIG. 5 ends. However, group policy information can be changed (e.g., as a result of usage or changes to a sharing agreement). In the event that policies are modified, group policy information is modified accordingly. Doing so enables the group policy management module to maintain the most up-to-date group policy information.

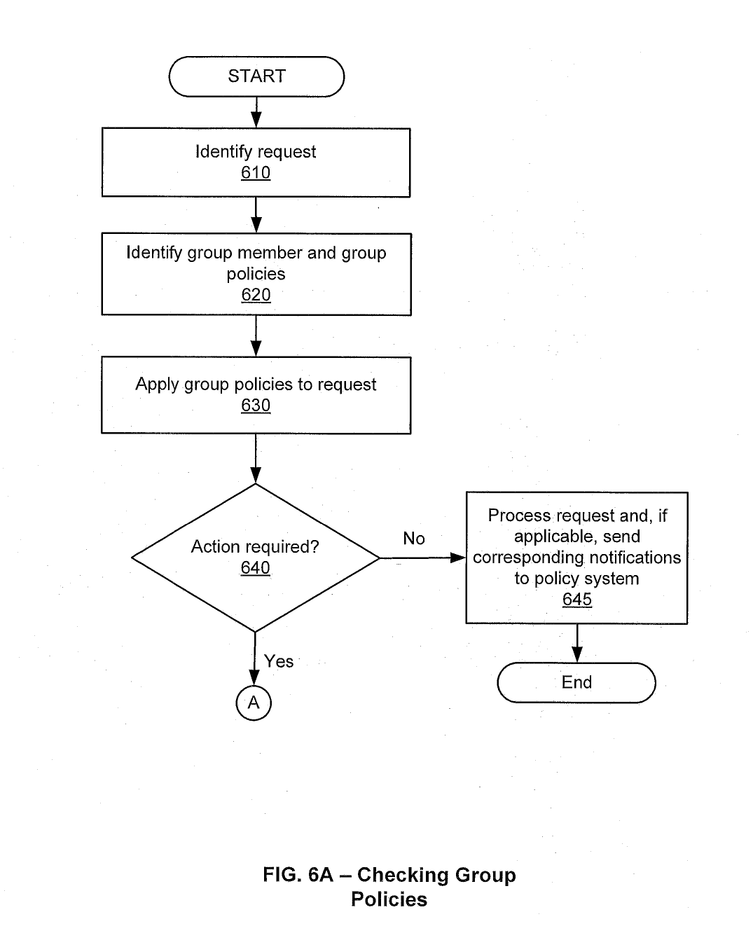

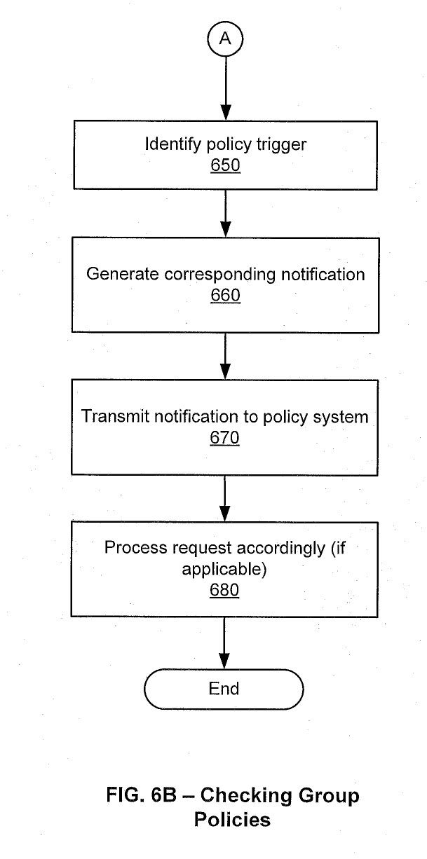

FIGS. 6A and 6B illustrates a process for checking group policies. The process of FIGS. 6A and 6B may be performed, whenever the charging engine receives a request (e.g., service request) from a group member.

The process of FIG. 6A begins at 610. At 610, a request, which is received from a group member, is identified. The request is a request to receive a service. In this case, the service comprises use of a resource, where such a resource is part of the pool of resources to be shared by the group.

Thereafter, the process continues to 620, where the group member submitting the service request is identified. Any and all group policies applicable to the particular group member are also identified by the group policy management module at 620. In order to do so, the set of policies applicable to the group is retrieved. One or more of these policies may be eliminated based on particular characteristics of the individual group member submitting the request. For example, if the group member submitting the request is an adult, any and all policies related to a child (e.g., a policy prohibiting texting during school hours) may be eliminated, given that those policies do not apply to the adult. Any policies that apply globally (e.g., regardless of who the group member submitting the request is) will be maintained as part of the policies applicable to the group member.

At 630, the policies identified in 620 are applied to the request. The process continues to 640. At 640, a determination is made as to whether the request requires some form of action, per the group policies. If no action is required, the process continues to 645. At 645, the request is processed by the charging engine. Processing the request may involve allowing the service usage to occur, calculating applicable charges for the service usage, and applying such charges to the pool of resources and the corresponding balances therein. In some cases, a notification indicating the service usage and the resulting balances for the pool of resources is sent to the policy system as part of 645. Such a notification may trigger the policy system to modify previously defined policies. At this point, the process ends.

Alternatively, if some form of action is required, per the group policies, the process continues to 650 in FIG. 6B. Action may be required if the request will meet or exceed pre-defined balances for one or more categories of resources within the pool of resources. Action may also be required if the service being requested requires a different (e.g., higher or discounted) rate based on the current balances for the pool of resources or if the request calls for use of a new service. Even further, action may be required if the request requires a different bandwidth to be applied to the service (e.g., such as when throttling a service when certain bandwidth limits are reached by a group member or the group as a whole to ensure fair usage is maintained for other users).

Action may also be required if the request violates policies defined by the group owner. For example, parental controls may exist to prohibit children from viewing adult sites, texting or using social media networks during school hours, and/or using the internet after certain hours. In the event that a request is submitted by a child to perform any of the above, related policies will set off a policy trigger to that effect.

At 650, the policy trigger is identified. Once a policy trigger is identified, the process continues to 660. At 660, the charging engine generates a corresponding notification intended for a policy system. The contents of the notification may include a description of the policy and/or the policy trigger. In addition, the notification may be generated in the form of a message, a tag, or the like.

The notification is then transmitted to the policy system at 670. The policy system may then utilize the contents of the notification to take the proper action. Thereafter, the process continues to 680. At 680, the charging engine may process the request, if applicable. In cases where the request is allowable, the charging engine will allow the service to be provided to the group member and simultaneously calculate and apply corresponding charges to the pool of resources and balances remaining therein. A notification may also be transmitted to the policy system once the request is processed to indicate the service usage and the resulting balances. Such a notification may trigger the policy system to modify previously existing policies. However, if the request is not allowable (per group policies), the request will not be processed in 680. At this point, the process ends.

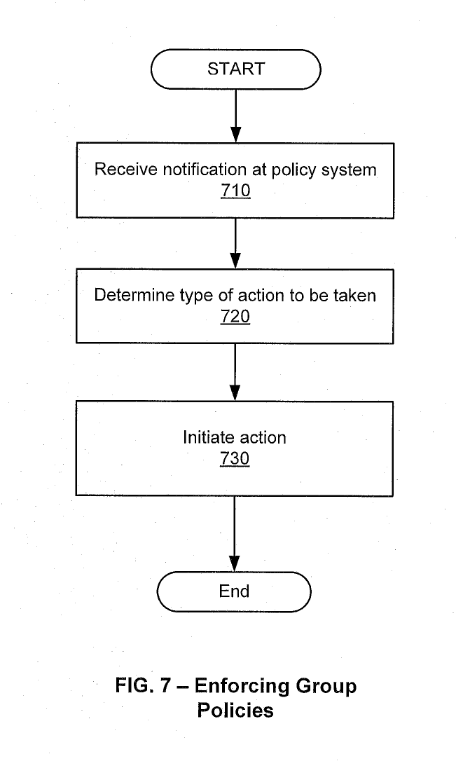

FIG. 7 illustrates a process for enforcing group policies. The process of FIG. 7 may be performed by a policy system, such as policy system 150 of FIG. 1, and more particularly, by a policy enforcement module, such as policy enforcement module 170 of FIG. 1. In addition, the process of FIG. 7 may be performed in response to receiving a notification from a charging engine (such as charging engine 130 of FIG. 1).

The process of FIG. 7 begins at 710. At 710, the policy system receives a notification from the charging engine. This notification may be received in the form of a message, a tag, or the like. Moreover, the contents of the notification may identify the policy and/or the policy trigger that has been encountered by the charging engine while attempting to process a request for service.

At 720, the policy system identifies the type of action to be taken in response to the notification. Such information may be found using policy information generated by a policy rules engine (e.g., such as policy rules engine 160 of FIG. 1). The process continues to 730, where the policy system can initiate the action identified in 720. Doing so enables the policy system to enforce pre-defined policies. Such actions may include the transmission of notifications to the group owner, group member, and/or the group. Other actions may involve applying a different rate or a different bandwidth to the service. Even further actions may include denying the service based on balances and/or customer preferences. A number of other actions may also be possible.

At this point, the process ends. The process of FIG. 7 is repeatable and may be performed any time the policy system receives a notification from the charging engine.

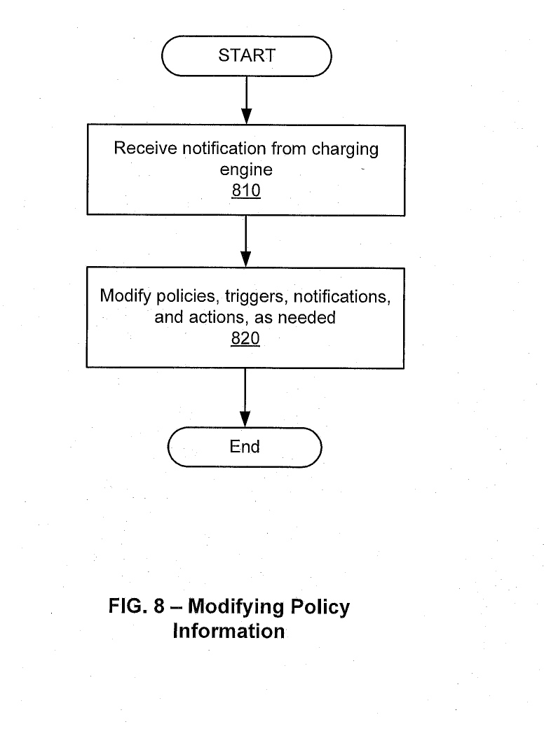

FIG. 8 is an example process for modifying policy information. The process of FIG. 8 may be performed by a policy system, such as policy system 150 of FIG. 1, and more particularly by policy rules engine 160 of FIG. 1.

The process of FIG. 8 begins at 810, where the policy system receives a notification from a charging engine. Such a notification may be received as a result of usage and/or service changes, which trigger the formation of new policies and/or the modification of existing policies. In addition, such a notification may be received in the form of a message, tag, or the like.

The process continues to 820. At 820, the policy system retrieves and modifies existing policies, triggers, notifications, and actions, as needed. For example, the policy system may add new policies, triggers, notifications, and actions and/or modify existing policies, triggers, notifications, and actions in response to the notification received at 810. Changes in policies may be a result of certain levels of usage of a resource, remaining balances within an account, and/or changes made to a service agreement.

At this point, the process of FIG. 8 ends. The process of FIG. 8 is repeatable and may be performed in response to notifications from the charging engine, which indicate usage and/or balance information for a subscriber. By performing the process of FIG. 8, the policy rules engine is able to maintain the most up-to-date policy information.

An Example Computing and Network Environment

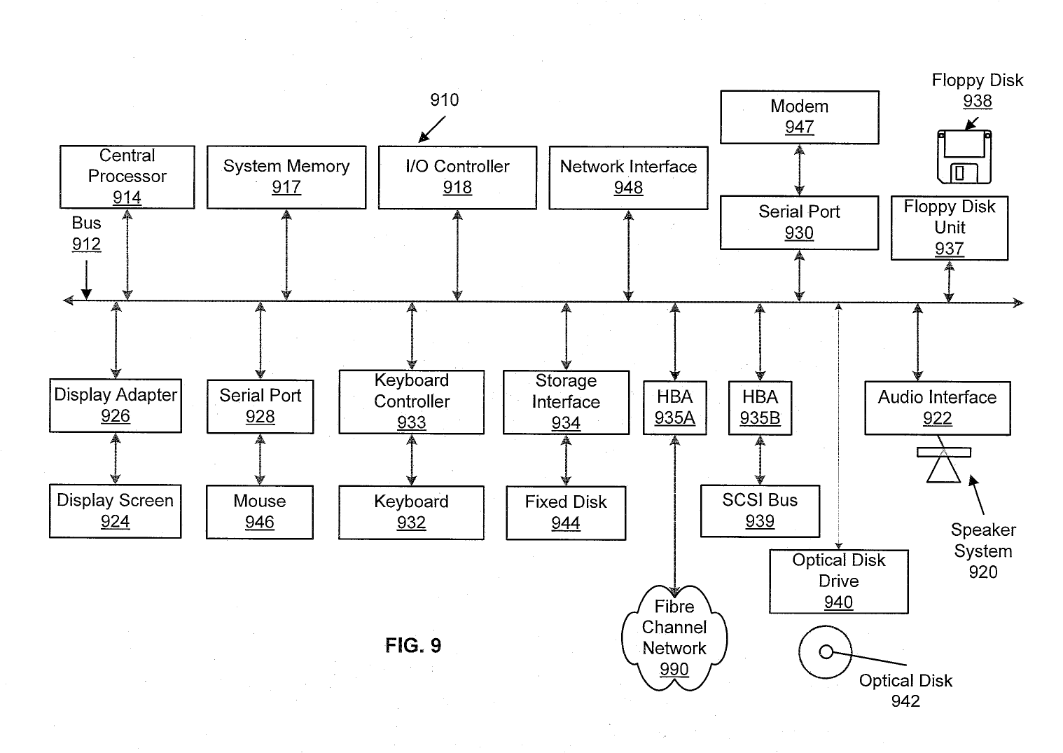

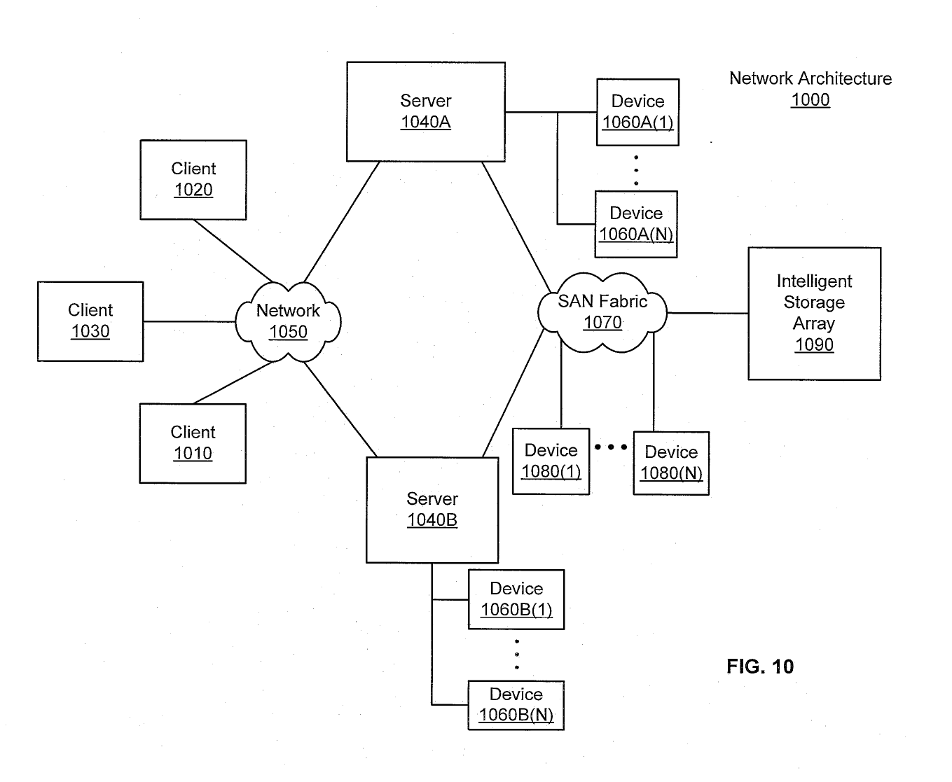

As shown above, the present invention can be implemented using a variety of computer systems and networks. An example of one such computing and network environment is described below with reference to FIGS. 9 and 10.

FIG. 9 depicts a block diagram of a computer system 910 suitable for implementing aspects of the present invention Computer system 910 includes a bus 912 which interconnects major subsystems of computer system 910, such as a central processor 914, a system memory 917 (typically RAM, but which may also include ROM, flash RAM, or the like), an input/output controller 918, an external audio device, such as a speaker system 920 via an audio output interface 922, an external device, such as a display screen 924 via display adapter 926, serial ports 928 and 930, a keyboard 932 (interfaced with a keyboard controller 933), a storage interface 934, a floppy disk unit 937 operative to receive a floppy disk 938, a host bus adapter (HBA) interface card 935A operative to connect with a Fibre Channel network 990, a host bus adapter (HBA) interface card 935B operative to connect to a SCSI bus 939, and an optical disk drive 940 operative to receive an optical disk 942. Also included are a mouse 946 (or other point-and-click device, coupled to bus 912 via serial port 928), a modem 947 (coupled to bus 912 via serial port 930), and a network interface 948 (coupled directly to bus 912).

Bus 912 allows data communication between central processor 914 and system memory 917, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 910 are generally stored on and accessed via a computer-readable medium, such as a hard disk drive (e.g., fixed disk 944), an optical drive (e.g., optical disk drive 940), a floppy disk unit 937, or other storage medium. Additionally, applications can be in the form of electronic signals modulated in accordance with the application and data communication technology when accessed via modem 947 or network interface 948.

Storage interface 934, as with the other storage interfaces of computer system 910, can connect to a standard computer-readable medium for storage and/or retrieval of information, such as a fixed disk 944. Fixed disk drive 944 may be a part of computer system 910 or may be separate and accessed through other interface systems. Modem 947 may provide a direct connection to a remote server via a telephone link or to the Internet via an internet service provider (ISP). Network interface 948 may provide a direct connection to a remote server via a direct network link to the Internet via a POP (point of presence). Network interface 948 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present invention. The devices and subsystems can be interconnected in different ways from that shown in FIG. 9. The operation of a computer system such as that shown in FIG. 9 is readily known in the art and is not discussed in detail in this application. Code to implement the present invention can be stored in computer-readable storage media such as one or more of system memory 917, fixed disk 944, optical disk 942, or floppy disk 938. The operating system provided on computer system 910 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 10 is a block diagram depicting a network architecture 1000 in which client systems 1010, 1020 and 1030, as well as storage servers 1040A and 1040B (any of which can be implemented using computer system 910), are coupled to a network 1050. Storage server 1040A is further depicted as having storage devices 1060A(1)-(N) directly attached, and storage server 1040B is depicted with storage devices 1060B(1)-(N) directly attached. Storage servers 1040A and 1040B are also connected to a SAN fabric 1070, although connection to a storage area network is not required for operation of the invention. SAN fabric 1070 supports access to storage devices 1080(1)-(N) by storage servers 1040A and 1040B, and so by client systems 1010, 1020 and 1030 via network 1050. Intelligent storage array 1090 is also shown as an example of a specific storage device accessible via SAN fabric 1070.

With reference to computer system 910, modem 947, network interface 948 or some other method can be used to provide connectivity from each of client computer systems 1010, 1020 and 1030 to network 1050. Client systems 1010, 1020 and 1030 are able to access information on storage server 1040A or 1040B using, for example, a web browser or other client software (not shown). Such a client allows client systems 1010, 1020 and 1030 to access data hosted by storage server 1040A or 1040B or one of storage devices 1060A(1)-(N), 1060B(1)-(N), 1080(1)-(N) or intelligent storage array 1090. FIG. 10 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1010). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof, including the specialized system illustrated in FIG. 1.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

What is claimed is:

1. A method comprising:
receiving a request, wherein
the request is received from a group member,
a group comprises a plurality of group members,
the plurality of group members comprises the group member,
the group shares a pool of resources, and
the request comprises a request for usage of a resource from the pool of resources; and
determining if the request requires action by a policy system, wherein
the determining is based on group policy information,
the group policy information comprises information regarding one or more policies applicable to the group.

2. The method of claim 1, further comprising:
receiving policy information, wherein
the policy information comprises information regarding one or more policies for one or more subscribers,
the policy information is generated by the policy system, and
the policy information is received by a charging engine.

3. The method of claim 2, further comprising:
determining the group policy information, wherein
the determining comprises associating at least a portion of the policy information with the group; and
storing the group policy information, wherein
the group policy information is stored at the charging engine.

4. The method of claim 1, further comprising:
in response to the determining that the request requires the action,
generating a notification, and
transmitting the notification to the policy system.

5. The method of claim 4, further comprising:
receiving the notification, wherein
the notification is received by the policy system;
identifying the action to be taken; and
initiating the action.

6. The method of claim 1, further comprising:
identifying the group;
identifying the group members; and
identifying the pool of resources to be shared by the group.

7. The method of claim 1, further comprising:
modifying the group policy information.

8. A computer readable storage medium configured to store instructions that, when executed by a processor, are configured to cause the processor to perform a method comprising:
receiving a request, wherein
the request is received from a group member,
a group comprises a plurality of group members,
the plurality of group members comprises the group member,
the group shares a pool of resources, and
the request comprises a request for usage of a resource from the pool of resources; and
determining if the request requires action by a policy system, wherein
the determining is based on group policy information,
the group policy information comprises information regarding one or more policies applicable to the group.

9. The computer readable storage medium of claim 8, wherein the method further comprises:
receiving policy information, wherein
the policy information comprises information regarding one or more policies for one or more subscribers,
the policy information is generated by the policy system, and
the policy information is received by a charging engine.

10. The computer readable storage medium of claim 9, wherein the method further comprises:
determining the group policy information, wherein
the determining comprises associating at least a portion of the policy information with the group; and
storing the group policy information, wherein
the group policy information is stored at the charging engine.

11. The computer readable storage medium of claim 8, wherein the method further comprises:
in response to the determining that the request requires the action,
generating a notification, and
transmitting the notification to the policy system.

12. The computer readable storage medium of claim 11, wherein the method further comprises:
receiving the notification, wherein
the notification is received by the policy system;
identifying the action to be taken; and
initiating the action.

13. The computer readable storage medium of claim 8, wherein the method further comprises:
identifying the group;
identifying the group members; and
identifying the pool of resources to be shared by the group.

14. The computer readable storage medium of claim 8, wherein the method further comprises:
modifying the group policy information.

15. An apparatus comprising:
a processor; and
a memory, coupled to the processor, wherein the memory is configured to store instructions executable by the processor to:
receive a request, wherein
the request is received from a group member,
a group comprises a plurality of group members,
the plurality of group members comprises the group member,
the group shares a pool of resources, and
the request comprises a request for usage of a resource from the pool of resources, and
determine if the request requires action by a policy system based on group policy information, wherein
the group policy information comprises information regarding one or more policies applicable to the group.

16. The apparatus of claim 15, wherein the instructions are further executable to:
receive policy information, wherein
the policy information comprises information regarding one or more policies for one or more subscribers,
the policy information is generated by the policy system, and
the policy information is received by a charging engine.

17. The apparatus of claim 16, wherein the instructions are further executable to:
determine the group policy information by associating at least a portion of the policy information with the group, and
store the group policy information, wherein
the group policy information is stored at the charging engine.

18. The apparatus of claim 15, wherein the instructions are further executable to:
generate a notification, in response to determining that the request requires the action, and
transmit the notification to the policy system.

19. The apparatus of claim 18, wherein the instructions are further executable to:
receive the notification, wherein
identify the action to be taken; and
initiate the action.

20. The apparatus of claim 15, wherein the instructions are further executable to:
identify the group;
identify the group members; and
identify the pool of resources to be shared by the group.
